(19) United States
(12) Patent Application Publication
(10) Pub. No.: US 2012/0078705 A1
(43) Pub. Date: Mar. 29, 2012

(54) ONLINE SYSTEM AND METHOD FOR PRODUCT DISCOUNTS

(76) Inventor: Blake F. Megdal, Los Angeles, CA (US)

(21) Appl. No.: 13/220,132

(22) Filed: Aug. 29, 2011

Related U.S. Application Data
(60) Provisional application No. 61/387,361, filed on Sep. 28, 2010.

(51) Int. Cl. G06Q 30/00

(52) U.S. Cl. 705/14.39

(57) ABSTRACT

An online advertising system and method including displaying e-tailers offering a product for sale; displaying a price for the specified product for each e-tailer that offers the product for sale; aggregating information about which e-tailers have an existing revenue sharing arrangement involving the product and the amount of revenue the e-tailers are willing to share with consumers; calculating a price discount for each e-tailer with the existing revenue sharing arrangement, based on the product and an amount of revenue each e-tailer is willing to share; calculating a final price for the product for each e-tailer responsive to the amount of revenue respective e-tailers are willing to share with consumers and the price of the product; and displaying the one or more e-tailers offering the specified product in a list ordered according to the final prices for said specified product calculated for each of the e-tailers.

### CROSS REFERENCE TO RELATED APPLICATIONS

This patent application claims the benefits of U.S. Provisional Patent Application Ser. No. 61/387,361, filed on Sep. 28, 2010 and entitled “Online System And Method For Product Discounts Collateralized By Vendor To Retailer CPC-CPA Transactions,” the entire content of which is hereby expressly incorporated by reference.

### FIELD OF THE INVENTION

The present invention relates to an online system and method that allows electronic retailers (e-tailers) to offer off-site consumers a discount on certain products that are derived from and backed by advertising revenue the retailer generates within its site by selling Cost-per-Click (CPC), Cost-per-Action (CPA), and/or Cost Per Impression (CPM) advertisements to their vendor (manufacturer) clients.

### BACKGROUND

The internet has increasingly become a virtual marketplace for the sale of goods and services. The degree of online price transparency among competing products and the retailers that sell them is unmatched by any other channel. Increasingly, internet and brick-and-mortar shopping are merging with the advent of applications that allow shoppers to scan in-store bar codes and shop for that product online.

One of the major sources for online product price transparency is the myriad of online tools that aggregate, price and display products from a multitude of competing electronic retailers (e-tailers). General search engines like Yahoo™, Bing™ and Google™ have come to dominate the product search market, while smaller comparison shopping engines (CSEs) also operate within the product search space. Similarly, coupon engines have gained traction, affording consumers with a central market for all their coupon needs.

Given their ability to influence transactions and shopper behavior, product search and coupon engines are particularly ripe for both retailer and manufacturer advertising spending. Retailers advertise to promote themselves as the best store for consumers to make purchases at, while manufacturers advertise to ensure that consumers buy their products over competing brands.

Product search engines, make money by charging retailers and manufactures for priority placement at the top or to the side of product search results. Typically, product search engines employ a Cost-per-Click (CPC) pricing model, whereby merchants pay each time a customer clicks on the merchants' sponsored link.

Over the years, innovation in the product search space has been relatively tepid. Product search engines have largely competed along the same metrics as general search engines: number of sites catalogued, speed of searches, usability of the site and effectiveness of results. A few have added alternative or proprietary forms of product payment, loyalty programs and the like. While traditional product searches allow retailers and manufacturers to advertise to shoppers individually, they lack an effective and streamlined mechanism for vendors and retailers to jointly target shoppers. The vast majority of product search advertisements take one of two forms: 1) Retailer A promotes itself over all other Retailers for the right to sell Product A to a consumer; or 2) Product A competes with all other Products for a consumer's purchase at any Retailer. Within this model, there is no way, for example, for Product A to compete with Product B for a sale at Retailer A. In addition, Product A cannot suggest that consumers buy its product at Retailer A over Retailer B.

The static and individualized relationship between manufacturer and retailer advertising on product search engines is inconsistent with the way large brands and retailers operate off-line. In the brick-and-mortar context, vendors and retailers heavily collaborate in promoting products. Newspaper circulars, for example, are joint marketing campaigns between retailers and the manufacturers who are promoted within them. Manufacturers issue coupons which can be redeemed across retailers but are often coupled with specific promotions at specific retailers.

Retailers are just beginning to apply their brick-and-mortar merchandising principles to their online storefronts. Large e-tailers are experimenting with dedicated in-store branded pages. More retailers are using banner and dynamic visual ads which vendors can purchase for a price. Some companies allow retailers that use large proprietary search engines to allow vendors to pay for better ranking in product results. This model can be thought of as a vendor specific search engine optimization (SEO) platform.

In the future, retailers are likely to become more sophisticated in the way they monetize both their internal search results and product category page displays. Product promotion on individual e-tailing sites will be monetized in much the same way product and general search engines are today. Ultimately, a market for virtual slotting and shelf space will evolve, whereby brands/vendors pay for top slotting on specific e-tailers' search query or product category pages on CPC, Cost-per-Action (CPA), and/or Cost Per Impression (CPM) basis.

The establishment of a CPC/CPA/CPM market within individual e-tailing sites will generate significant revenue for e-tailers in and of itself. With internal CPC and CPA campaigns on certain products, e-tailers will make money when consumers browse their website and not just when they make purchases. It also affords e-tailers with pricing advantages that can be used off-site in new and innovative ways. The present invention is a system and method for implementing a new CPC/CPA/CPM market for the retailers, vendors and consumers.

### SUMMARY

In some embodiments, the present invention is an online advertising method. The method includes providing a product search engine for displaying one or more e-tailers offering a specified product for sale; displaying a regular price for the specified product for each e-tailer that offers said specified product for sale; aggregating information about which ones of the one or more e-tailers have an existing revenue sharing arrangement involving the product and an amount of revenue the e-tailers are willing to share of the revenue sharing arrangement with consumers; and calculating a price discount for each e-tailer with the existing revenue sharing arrangement, based on the specific product and an amount of revenue each e-tailer with the existing revenue sharing arrangement is willing to share with the consumers. The method further includes calculating a final price for said specified product for each e-tailer with the existing revenue sharing arrangement responsive to the amount of revenue respective e-tailers are willing to share with consumers and said regular price of the specified product for the respective e-tailer's; and displaying the one or more e-tailers offering the specified product in a list ordered according to the final prices for said specified product calculated for each of the e-tailers.

In some embodiments, the present invention is a product search engine including: a system controller for parsing user queries about a product; displaying product information for a plurality of e-tailers, e-tailers' pricing information, e-tailers' data on whether a respective has an existing revenue sharing arrangement related to the product, data on whether the respective e-tailer is willing to share any portion of the existing revenue sharing arrangement with consumers; and calculating a final price for the product for each -e-tailer based on the portion of the existing revenue sharing arrangement to be shared with consumers; and a display controller for displaying pricing data and product discount results for each e-tailer in an order determined by each e-tailer's pricing data and product discount data on a display.

In some embodiments, the final price for the specified product may be calculated by subtracting all or a portion of the calculated price discount from the respective regular prices of the specified product.

In some embodiments, the existing revenue sharing arrangement may be based on CPC, CPA, and/or CPM. The method may further include generating a coupon for the price discount, and electronically redeeming said coupon. Further, the coupon may be targeted to particular customers.

In some embodiments, a user may activate one of the one or more e-tailers offering the specified product in the list to be redirected to a purchase webpage of said one of the one or more e-tailers.

In some embodiments, the respective amount of revenue an e-tailer is willing to share with the consumers may be dynamically changed, for example by an auction-like mechanism.

### BRIEF DESCRIPTION OF THE DRAWINGS

FIG. 1 is an exemplary block diagram, according to some embodiments of the present invention.

FIG. 2 is an exemplary block diagram of a product search engine module, a coupon generating mechanism, and ad platform, according to some embodiments of the present invention.

FIG. 2A is an exemplary process flow for an online advertising method, according to some embodiments of the present invention.

FIG. 3 is an exemplary process flow demonstrating how product discounts are incorporated into product search results, according to some embodiments of the present invention.

FIG. 4 is an exemplary process flow demonstrating how a coupon generator module incorporates product discounts, according to some embodiments of the present invention.

FIG. 5 is an exemplary process flow of how product discounts can be used to re-target e-tailers' customers, according to some embodiments of the present invention.

### DETAILED DESCRIPTION

In some embodiments, the present invention includes a product search engine, a coupon generator module and/or other digital platform that allow e-tailers to discount the price of certain products by a percentage of advertising revenue the e-tailer generates from promoting the product within its website. The invention allows e-tailers to share revenue with online or off-site consumers from cost/revenue per some sort of user action, such as Cost-per-Click (CPC), Cost-per-Action (CPA), Cost Per Impression (CPM), and the like transactions it makes between itself and its vendor/manufacturer clients for priority placement on the e-trailers' website. The invention includes a product search engine that aggregates product prices and incorporates CPC/CPA/CPM backed product discounts, a coupon generator module, such a website that generates product coupons in the same fashion, and an advertising system that allows e-tailers to incorporate CPC/CPA/CPM e-tailer vendor backed discounts via email, to share internal CPM vendor revenue with online or off-site consumers, and to display ads or perform other digital advertisements that incorporate such product discounts. The invention also includes an accounting module and a reporting module for keeping track of the retailers', consumers' and vendors' accounts and for generating a variety of different reports for different users. Although CPC/CPA/CPM is used as an example for a revenue sharing scheme, other revenue sharing schemes based on any action of the user, or merchant are well within the scope of the invention.

In some embodiments, the product search engine aggregates products and prices similar to other product search engines but would allow retailers' to reduce the price of an offered product by a specified percentage of the CPC/CPA/CPM revenue retailers generate from promoting that product within their site. The invention keeps track of the retailers' internal CPC/CPA/CPM transactions for a specified product or brand of products; sometime whole lines of products; or all products by a specific vendor. The coupon generator module displays product coupons that are collateralized by the retailers' internal CPC/CPA/CPM transactions for the specified product.

In some embodiments, the invention uses targeted banner ads, emails, coupons off-site with discounts backed by the retailers' CPC/CPA/CPM revenue. For example, suppose Brand A is paying Retailer A $5.00 per action when a user purchases their product after clicking on a sponsored result within the retailers' product category or search results. Retailer presumably has no interest in sharing its CPA revenue with on-site customers because it doesn't have to. Accordingly, the transaction will occur without any further price inducement.

Now let's say that Retailer A is willing to share 50% of its CPA revenue with consumers to attract consumers to their website. The product search engine of the invention is capable of offering users a $2.50 product discount ($5.00*0.5). The coupon generator modules offers prospective buyers a coupon in the amount of $2.50 that can be used electronically on the retailers' website or printed and redeemed at the retailers' brick-and-mortar store. In some embodiments, the invention allows the retailer to send an email coupon, targeted banner ad, or other digital advertisement that incorporates the product discount.

In this new environment enabled by the system and method of the present invention, retailers and vendors can work together in what amounts to a joint digital advertising campaign. The manufacturer pays for part of the promotion by purchasing advertising within the retailers' website and the retailer contributes by foregoing a portion of the manufacturers' ad spending and offering it to the consumer. In fact, the retailer may not be giving up anything since the transactions may not have taken place without the product discount. In effect, the invention allows Vendor A to promote its product over other brands at the same time the Retailer A is promoting itself as the right place to purchase Product A.

Vendors (manufacturers) also benefit because they get, in effect, free online or off-site marketing. While they have purchased priority real estate (position) within a retailer's website, the Retailer is contributing to further market their product off-site. The scope of the manufacturers ad buy is multiplied.

The invention allows Retailers to use product discounts to attract consumers to their store. The process mirrors the concept of “loss leaders” in the brick and mortar environment, where retailers discount certain products to lure customers to their stores in the hope they will purchase other products. Except in this case, both the vendor and manufacturer share the cost of providing for “loss leaders” and there is no real loss, but instead, merely foregone profit.

Another benefit to the retailer is that manufacturers will be willing to spend more money to advertise internally at the retailers' website if they know such expenditures will also be used to promote their products off-site. Put differently, manufacturers will pay more for internal ad buys if they will be used off-site as well. The result is that the disclosure will result in higher CPC/CPA/CPM rates retailers' can generate within their website. The process becomes a positive-feedback loop as higher CPC/CPA/CPM rates will allow retailers to offer even steeper discounts to prospective customers.

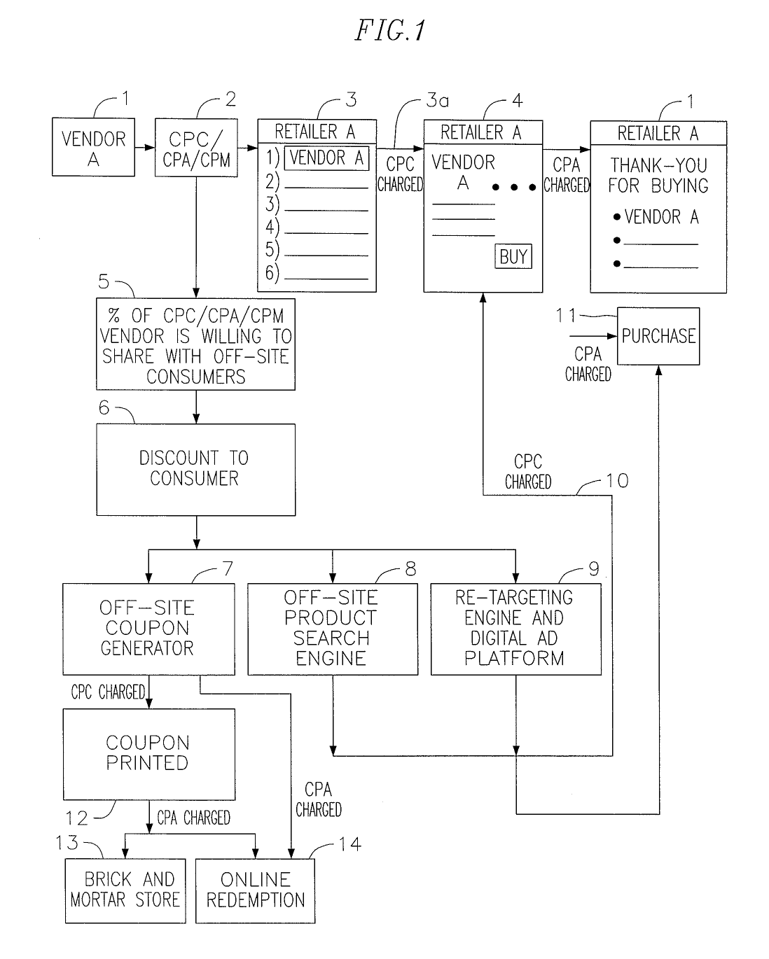

FIG. 1 is an exemplary block diagram, according to some embodiments of the present invention. As shown, Vendor A (1) buys priority virtual shelf space on Retailer A's website on a CPC/CPA/CPM basis (2). When a user clicks on Vendor A's promoted product on Retailer A's website (3), Vendor A pays Retailer A at the CPC rate (3a). If a user then purchases Vendor A's product, Vendor A pays Retailer A at the CPA rate (4). The CPC/CPA/CPM rates may be for any purchase of a promoted brand.

Retailer A determines if and what percentage of Vendor A's CPC/CPA/CPM revenue it is willing to share with consumers (5). During this process, Retailer A can also utilize the present invention to manage how and on what products it is willing to share revenue on. For example, Retailer A can limit revenue sharing on certain products, product categories, geographical areas, and other constraints. Retailer A can limit revenue sharing on the basis of certain user demographics and/or shopping behavior. In some embodiments, the present inventor provides a user interface for the vendors and retailers to register with the system. Upon a successful registration, they can change the appropriate parameters, percentages, and the like.

Depending on Retailer's percentage share and the revenue sharing (CPC/CPA/CPM) rate, the system (one or more computers) according to the present invention calculates the product discount that can be made available to consumers (6). The product discount amount is then incorporated into product search engine results (8), a coupon generator module (7), and optionally, a digital advertisements module (9).

In some embodiments, when a user clicks on (activates) the product listing in the product search engine, the product search engine logs the click and redirects the user to Product A's purchase page at Retailer A. The redirect URL identifies the product search engine where the transaction originated, the product, price and product discount (10). When the user accesses Product A's purchase page at Retailer A, the system enables the Retailer A to charge Vendor A at the CPC rate per the CPC/CPA/CPM arrangement between Vendor and Retailer A (10), recorded within the system. When the purchase is made thereafter, the system may further charge Vendor A at the CPA rate (11) on Retailer A's behalf. This way, Retailer A makes the sale at the discounted product price and can encourage the user to shop for further items at the store or its website.

In some embodiments, when a user clicks on and/or prints a coupon, the system records a charge from Vendor A to Retailer A at the CPC rate (12). Users can print out the coupon, store it on their loyalty card, or opt for other ways to redeem it at Retailer A's brick-and-mortar location (13). In addition, the system provides the users with capability to redeem the coupon electronically, using a coupon code or other mechanism at Retailer A's website (14). Upon in-store or website redemption, the system pays/credits Retailer A at the CPA rate (13)(14) on behalf of Vendor A. This way, the Retailer need not report sales dating back to the product search engine or coupon generator.

In some embodiments, once the user is at the Retailer's store, the Retailer or the Retailer's e-commerce and/or ad management systems may handle the CPC/CPA/CPM charges to the Vendor.

In some embodiments, the system and method of the present invention allow the CPC/CPA/CPM product discount to be used in varying forms of digital advertisements targeting consumers. For example, when a user at Retailer A's website clicks on or adds Vendor A's product to their shopping cart and does not complete a purchase, the product discount can be used by a re-targeting engine of the present invention to offer the user the product discount via an email, display ads or other targeted advertisement (9). The system can target the selected item, any related item(s), and/or other items. If the user clicks on any of the re-targeting mechanisms, the system credits Retailer A at the CPC rate (10). If the user ends up purchasing Vendor A's product, the Vendor is paid at the Vendor CPA rate (11).

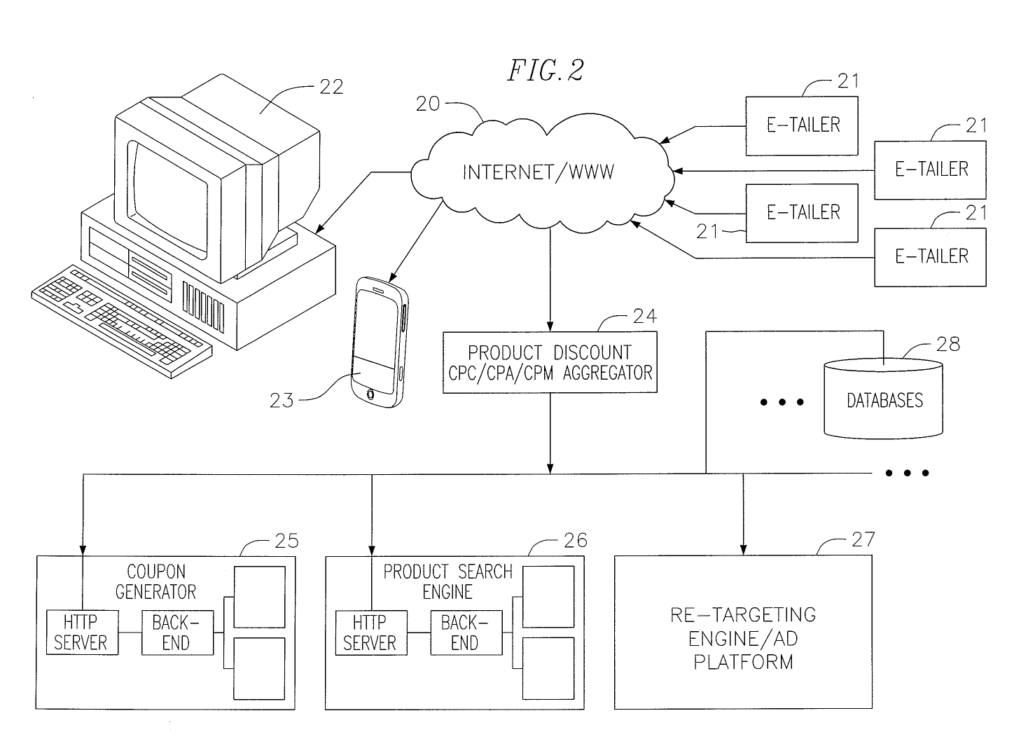

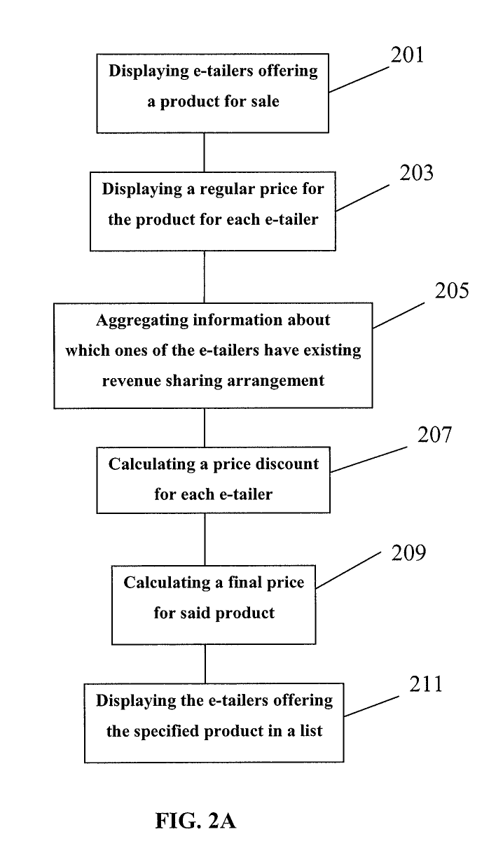

FIG. 2 is an exemplary block diagram of a product search engine module and a coupon generating mechanism, according to some embodiments of the present invention. E-tailers 21, a product search engine 26 executing on one or more computers (not shown), a coupon generator module 25 executing on one or more computers (not shown), and users on computers 22 and/or mobile devices 23 communicate and are connected via a computer network 20, for example, the Internet. The product search engine includes a web server and other back end systems. The web server generates and serves web pages to users and e-tailers. One or more databases 28 in the back-end systems store e-tailer information, including products, pricing, internal e-tailer-vendor CPC/CPA/CPM data, percentage of the (e.g., CPC/CPA/CPM) revenue e-tailers are willing to share with users, and other relevant information.

E-tailers provide the product search engine and coupon generator with product inventory, pricing, internal revenue sharing (e.g., CPC/CPA/CPM) arrangements it has with vendors, the percentage of CPC/CPA/CPM revenue e-tailers are willing to share with users, applicable sales tax, shipping costs and other relevant information.

Users, using the computers 22 and/or mobile devices 23, access the product search engine and coupon generator module to shop for products and/or coupons. Both mechanisms return product results and/or coupon to users via the user's web browser, or mobile device application, or any similar digital mechanism. Product search engine results include product information, retailer information, product discount information, shipping and other relevant information.

The product search engine 26 and coupon generator module 25 may have an interface for e-tailers to update CPC/CPA/CPM transactions, modify the (e.g., CPC/CPA/CPM) revenue sharing percentages, and manage other factors of the platform such as, which products, product categories, geographical constraints and other similar management type functionality.

In some embodiments, the product search engines and top coupons are ranked by best value to the user. For the product search engine, the e-tailer's position on the result page is determined by the final price of the product to the consumer. The final price includes such factors as the retail price, the shipping price, sales tax and finally the product discount offered by the retailer. The lower the final price to the consumer, the higher the e-tailer's result will be. The e-tailer's name, logo or corporate identity may be displayed so users can readily identify where the offer is coming from.

The coupon generator module 25 operates in similar fashion and includes the value of the discount. Higher valued coupons for a given product or product category will be placed higher in the display results than those of lesser value. Again the e-tailer's name, logo or corporate identity are readily available to users.

The incentive for the retailer, therefore, is to share the highest percentage of CPC/CPA/CPM revenue with users so that they can ensure the highest placement on either the product search engine or coupon generator. The retailers can modify their percentage split in real time to make themselves more competitive on both systems. Accordingly, market mechanisms and competition will tend to make e-tailers' share revenue at higher percentages of their (CPC/CPA/CPM) revenue.

Vendors can similarly promote their products by increasing the amount of CPC/CPA/CPM they pay the e-tailers within their website. Assuming that the e-tailer will share a fixed percentage of the revenue with users, vendors can elevate their status off-site by increasing their CPC/CPA/CPM rates.

In some embodiments, as the product search engine and coupon generator module accumulate users, both monitor users' behavior, shopping habits, demographics and other vital information. Both systems can use such information along with e-tailer's product discount information to target users after they have left the product search engine and coupon sites, for examples, via email, display ads and other mechanism that will incorporate the e-tailer product discount information into targeted ads.

In some embodiments, the present invention is a product search engine including a system controller that parses user queries and pulls e-tailer's product information, e-tailer's pricing information, e-tailer's data on whether it has an existing CPC/CPA/CPM transaction related to the product within the e-tailer's site, data on whether the e-tailer is willing to share their internal CPC/CPA/CPM revenue with consumers (and if so, to what extent) from a database for the purpose of generating search results pages. The e-tailer pricing data and e-tailer's product discount results are then displayed by a display controller to users in an order determined by each e-tailer's pricing data and product discount data. The retailer product prices may relate to at least one of tangible goods or services offered by the e-tailer. The order in which e-tailer pricing and product discount data are displayed in the search results may be based on the product's final price to the user, which is calculated by subtracting the factor of the amount the e-tailer is earning from promoting the vendor's product within its website and the percentage the e-tailer is willing to share with consumers from the product's regular retail price at the e-tailer's website.

The invention provides the e-tailers with the capability to share revenue they generate within their website from vendor-e-tailer revenue sharing (e.g., CPC/CPA/CPM) transactions with the product search engine's users, that is, the potential buyers of the products. The product discounts may be based on a percentage of the revenue the e-tailer generates from the sale or promotion of the product from the vendor within its website. In some embodiments, the product search engine of the present invention may include an auction mechanism (capability) that allows e-tailers to (dynamically) change the percentage of revenue sharing and thus the amount of the product discount. For example, the e-tailers can bid and outbid others on the percentage of the CPC/CPA/CPM revenue they are willing to share with the consumers. The product search engine includes one or more databases that track and log transactions sent to e-tailer's website. Users may click on e-tailer's product offering and then be taken to the product's purchase page at the e-tailer's website where the price is discounted to reflect the product price discounted by the CPC/CPA/CPM revenue sharing arrangement.

FIG. 2A is an exemplary process flow for an online advertising method, according to some embodiments of the present invention. In some embodiments, the present invention includes providing a product search engine that displays one or more e-tailers offering a specified product for sale in block 201 and displaying product price(s) for each e-tailer that offers the product for sale, in block 203. The invention aggregate information on which e-tailers have an existing revenue sharing (e.g., CPC/CPA/CPM) transaction involving the product, and how much revenue the e-tailer is willing to share of the revenue sharing (e.g., CPC/CPA/CPM) transaction with consumers, in block 205. The information may be stored in one or more databases. Furthermore, the method according to the invention includes: calculating a price discount for each e-tailer based on the particular product and the amount of revenue (e.g., CPC/CPA/CPM) the e-tailer is willing to share with online or off-site consumers in block 207 and calculating a final price for each e-tailer by subtracting all or a portion of the price discount derived from the (e.g., CPC/CPA/CPM) revenue sharing from the e-tailer's regular price, in block 209. The one or more e-tailers offering the product are then displayed in a list, in block 211. The list may be ordered according to the discounted final product prices calculated for each of the e-tailers.

The product offered by an e-tailer may include a link to the e-tailer's purchase facility where users click on the e-tailer's result in the product search results and are directed to the e-tailer's purchase facility. Upon the user being directed to the e-tailer's purchase facility, the e-tailer's price reflects the product discount derived from the e-tailer sharing (e.g., CPC/CPA/CPM) revenue from the vendor for that certain product. The method may allow e-tailers a dynamic bidding system, similar to an auction that allows e-tailers to change the percentage of revenue they share (e.g., CPC/CPA/CPM) with consumers so as to adjust their position on the product search result lists.

The method of the present invention may further include gathering users demographics and shopping habits and preferences and customer data for customers making product purchases and searches on the product search engine, in a customer profile. The customer profile data may include one or more of demographic data; geographic data; income; gender; age; and purchase history. The method may allow e-tailers to change product discounts to certain customers having certain characteristics and purchase behavior. The method may further include aggregating user purchase data, browsing history, and other user behavior for users both using and purchasing product through the product search engine.

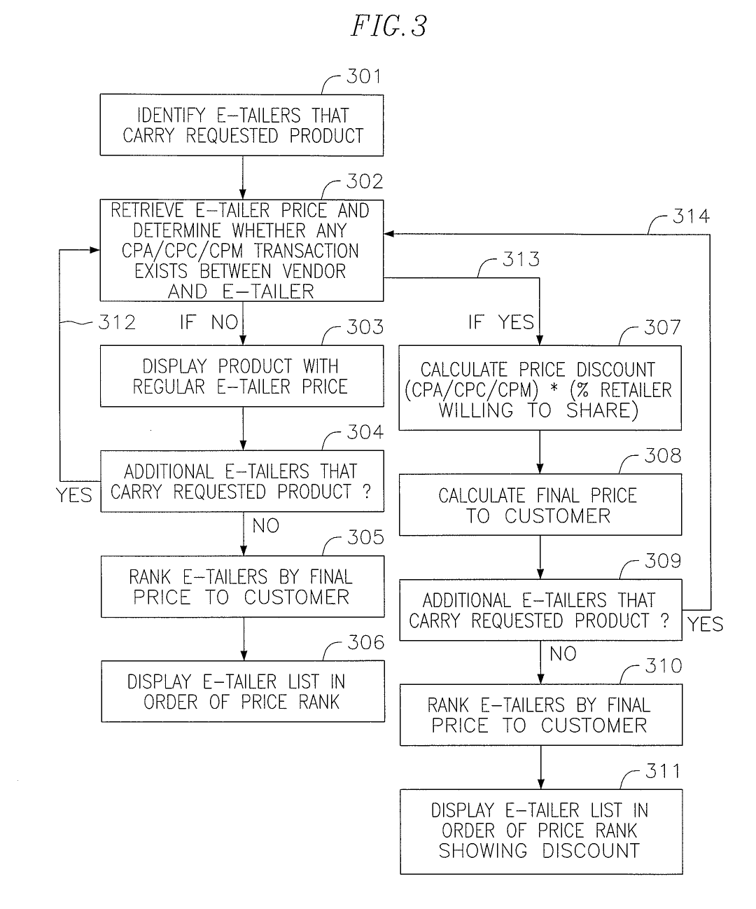

FIG. 3 is an exemplary process flow demonstrating how product discounts are incorporated into product search results, according to some embodiments of the present invention. Upon receiving user query, the product search engine (executing on one or more computers) identifies which e-tailers carry the requested product, as shown in block 301. For each e-tailer who carried the requested product, the system retrieves the product price and then determines whether the e-tailer has an existing CPC/CPA/CPM transaction on the product, in block 302. If not, the system (one or more computers) displays the product information with regular e-tailer price, in block 303. The system then checks if there are additional e-tailers that carry the requested product, in block 304. If so, the process returns (312) to block 302 and repeats the above steps for the additional e-tailer(s). If there are no additional e-tailers that carry the requested product, the system ranks the retrieved one or more e-tailers (block 305), for example, based on the prices they offer for the product, and displays the results to the user, in block 306.

On the other hand, if the retrieved e-tailer does have an existing CPC/CPA/CPM transaction involving the product (313), the system calculates the price discount, for example, the product of the price discount and the percentage the retailer is willing to share with consumers, in block 307. The system then calculates the final price to the consumer, in block 308. In block 309, the system determines if any other e-tailers carry the product. If so (314), the process returns to block 302, where the process continues until all e-tailers carrying the product (and having an existing CPC/CPA/CPM) have been accounted for. When all e-tailers carrying the product have been accounted for, the e-tailers are ranked, for example, by final product price or total discount (in block 310) and then displayed in ranked order to the user, in block 311.

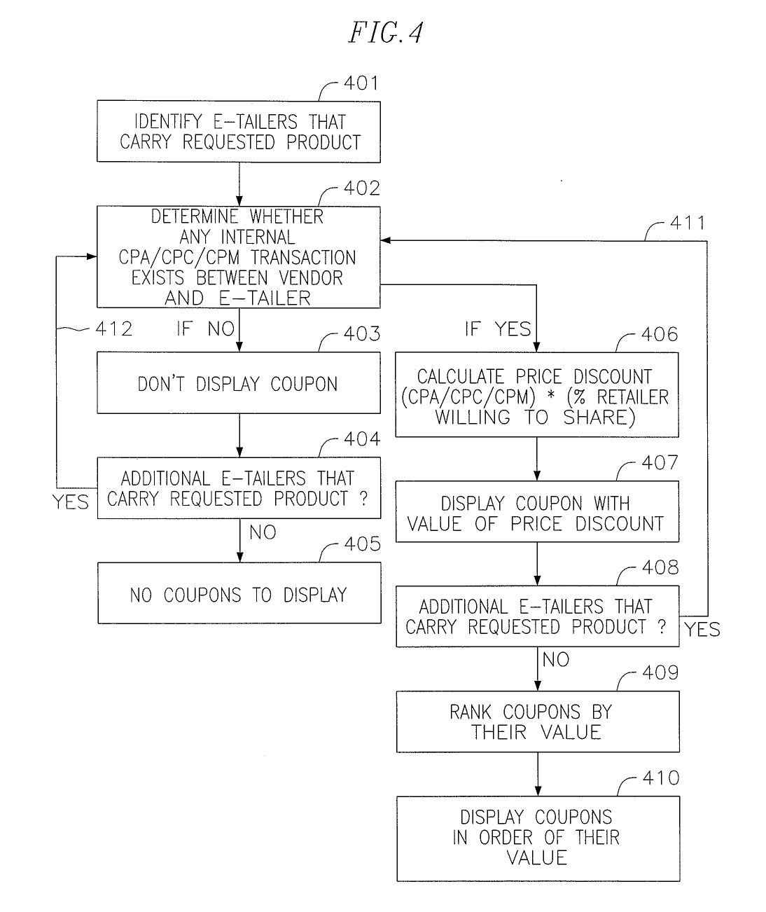

FIG. 4 is an exemplary process flow demonstrating how a coupon generator module incorporates product discounts, according to some embodiments of the present invention. Upon receiving a user query or a requested product, the system (one or more computers) identifies which e-tailers carry the requested product, in block 401. For each e-tailer, the system determines whether the e-tailer and vendor have a CPC/CPA/CPM arrangement related to the product, in block 402. If not, optionally, the system does not display a coupon for that retailer and product (block 403).

In block 404, the system determines if any other e-tailers carry the product. If so (412), the system returns to block 402, where the process continues until all e-tailers carrying the product have been accounted for. If a retailer does have an existing CPC/CPA/CPM transaction involving the product, the system in block 406 calculates the price discount, which may be the product of the price discount and the percentage the retailer is willing to share with consumers, or something similar. The system then displays the coupon (or an indication thereof) with the value of the discount in block 407. As shown in block 408, the system determines if any other e-tailers carry the product. If so (411), the system returns to block 402, where the process continues until all e-tailers carrying the product have been accounted for. If no e-tailers have any CPC/CPA/CPM transactions involving the product, the system optionally displays no coupons. If one or more e-tailers have any product discount for the given product, the system ranks coupons by their value in block 409, with the highest value coupon ranked at the top. The ranked coupon are then displayed to the user, in block 410.

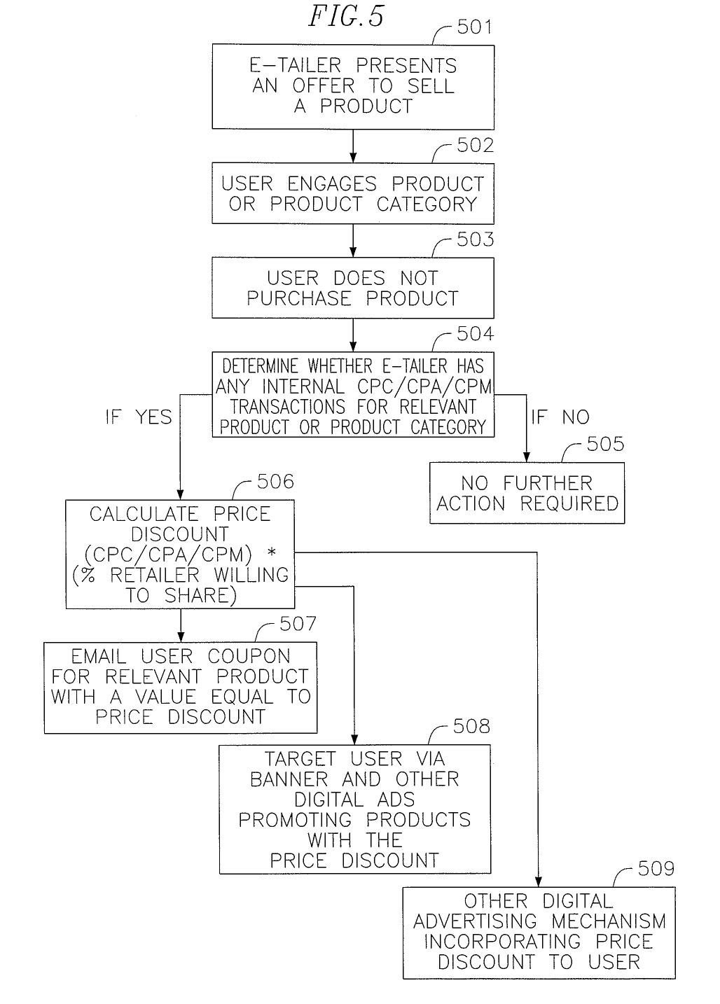

FIG. 5 is an exemplary process flow of how product discounts can be used to re-target e-tailers' customers, according to some embodiments of the present invention. In block 501, the e-tailer presents an offer for a product to be bought in a website, an online ad, or the like. In some embodiments, the user engages the e-tailer by visiting the e-tailer's website or clicking on an add with linkage to a website. The user engages a product or product category in block 502, while browsing the e-tailer's site. Within the e-tailer's site, the user's engagement of a product or product category can take a myriad of different forms or degree of commitment. For example, the user can browse a certain product category, can click on a specific product, could add a product to their shopping cart, and the like. When the user does not purchase a product (block 503), the system determines whether the specific e-tailer has any internal CPC/CPA/CPM transactions relevant to the user's interest, in block 504. If no, the system takes no action (block 505). If yes, in block 50, the system calculates the price discount it can offer the now off-site user, which may be the product of the price discount and the percentage the retailer is willing to share with consumers. The system may also target the user with digital advertisement offering the reduced price as incentive to get the user back to the e-tailer's store, in block 508. This mechanism can involve email marketing, display ad or any other digital mechanism targeted to the user (block 509). When the user clicks on any of the re-targeting mechanism, they are returned to the product purchase page of the e-tailer. They are then perhaps charged a CPC rate if the user does not purchase the product and eventually at the CPA rate should the user ultimately purchase the product.

In some embodiments, the respective amount of possible revenue share is dynamically changed depending on the performance of the ad, for example, within the retailers' site, since the effective CPA/CPA relative to the CPM may be changing depending on the click thru rates and the percentage of retailers who perform a certain action upon clicking on the ad.

In some embodiments, the vendor can increase the value of the discount to the user by dynamically changing how much it is willing to advertise within the retailers' website by increasing/decreasing the CPC/CPA/CPM rate it is currently paying.

In some embodiments the retailer and vendor may negotiate and incorporate a distinct figure from CPA/CPC/CPM that the vendor would be willing to pay the retailer if the retailer incorporates the vendors' product off-site and leads to traffic and or action the vendors' product page within the retailers' site—this may be called a CPP (Cost to Promote) and may be influenced by the CPA/CPC/CPM, but may not be directly attached and/or correlated with it.

In some embodiments, the retailer may advertise a daily deal or deep discount on a product for which the discount is backed or partially backed by the CPA/CPC/CPM transaction with its vendors.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. An online advertising method comprising:
providing a product search engine for displaying one or more e-tailers offering a specified product for sale;
displaying a regular price for the specified product for each e-tailer that offers said specified product for sale;
aggregating information about which ones of the one or more e-tailers have an existing revenue sharing arrangement involving the product and an amount of revenue the e-tailers are willing to share of the revenue sharing arrangement with consumers;
calculating a price discount for each e-tailer with the existing revenue sharing arrangement, based on the specific product and an amount of revenue each e-tailer with the existing revenue sharing arrangement is willing to share with the consumers;
calculating a final price for said specified product for each e-tailer with the existing revenue sharing arrangement responsive to the amount of revenue respective e-tailers are willing to share with consumers and said regular price of the specified product for the respective e-tailer's; and
displaying the one or more e-tailers offering the specified product in a list ordered according to the final prices for said specified product calculated for each of the e-tailers.

2. The method of claim 1, wherein calculating a final price for said specified product comprises subtracting all or a portion of the calculated price discount from the respective regular prices of the specified product.

3. The method of claim 1, wherein said existing revenue sharing arrangement is based on one or more of Cost-per-Click (CPC), Cost-per-Action (CPA), and Cost Per Impression (CPM).

4. The method of claim 1, further comprising generating a coupon or ad for the price discount.

5. The method of claim 4, further comprising electronically redeeming said coupon.

6. The method of claim 4, further comprising targeting said coupon or ad to a plurality of particular customers.

7. The method of claim 1, further comprising activating one of the one or more e-tailers offering the specified product in a list to be redirected to a purchase webpage of said one of the one or more e-tailers.

8. The method of claim 1, further comprising dynamically changing a respective amount of revenue a respective e-tailer with the existing revenue sharing arrangement is willing to share with the consumers.

9. The method of claim 1, further comprising providing an auction capability such that the e-tailers can bid their respective amount of revenue they are willing to share with the consumers.

10. A product search engine comprising:
a system controller for parsing user queries about a product; displaying product information for a plurality of e-tailers, e-tailers' pricing information, e-tailers' data on whether a respective has an existing revenue sharing arrangement related to the product, data on whether the respective e-tailer is willing to share any portion of the existing revenue sharing arrangement with consumers; and calculating a final price for the product for each -e-tailer based on the portion of the existing revenue sharing arrangement to be shared with consumers; and
a display controller for displaying pricing data and product discount results for each e-tailer in an order determined by each e-tailer's pricing data and product discount data on a display.

11. The product search engine of claim 10, further comprising one or more databases for tracking and logging transactions sent to each e-tailer's website.

12. The product search engine of claim 10, wherein the system controller is configured to calculate the final price for the product for each -e-tailer based by subtracting all or a portion of the portion of the existing revenue sharing arrangement to be shared with consumers from the respective prices of the product.

13. The product search engine of claim 10, wherein said existing revenue sharing arrangement is based on one or more of Cost-per-Click (CPC), Cost-per-Action (CPA), and Cost Per Impression (CPM).

14. The product search engine of claim 10, further comprising a coupon generating module for generating a coupon for the product discount.

15. The product search engine of claim 14, further comprising means for electronically redeeming said coupon.

16. The product search engine of claim 14, wherein the coupon generating module is configured to target said coupon to a plurality of particular customers.

17. The product search engine of claim 14, further comprising means for activating one of the one or more e-tailers offering the specified product in a list to be redirected to a purchase webpage of said one of the one or more e-tailers.

18. The product search engine of claim 10, further comprising means for dynamically changing a respective amount of revenue a respective e-tailer with the existing revenue sharing arrangement is willing to share with the consumers.

19. The product search engine of claim 10, further comprising means for providing an auction capability such that the e-tailers can bid their respective amount of revenue they are willing to share with the consumers.

20. The product search engine of claim 10, wherein said existing revenue sharing arrangement is dynamically changed.
